(19) United States
(12) Patent Application Publication
(10) Pub. No.: US 2026/0339363 A1
(43) Pub. Date: Oct. 29, 2026

(54) DEVICE FOR CONTROLLING STEAM FLOW IN A STEAM LINE

(71) Applicant: Forbes Marshall Technology Pvt Ltd, Maharashtra (IN)

(72) Inventors: Hrishikesh KULKARNI, Maharashtra (IN); Prashant RANADE, Maharashtra (IN)

(21) Appl. No.: 19/110,662

(22) PCT Filed: Sep. 12, 2023
(86) PCT No.: PCT/IB2023/059024

§ 371 Date: Mar. 11, 2025

(30) Foreign Application Priority Data
Sep. 12, 2022 (IN) 202221051982

(51) Int. Cl. G05D 7/06; F28F 27/00

(52) U.S. Cl. CPC G05D 7/0635; F28F 27/00

(57) ABSTRACT

The present disclosure envisages a device for controlling steam flow in a steam line. The device includes a control valve positioned along the steam line. A first pressure sensing unit is positioned upstream of the control valve to sense the pressure of steam. A temperature sensing unit is provided downstream of the heat exchanger to sense the temperature of fluid led out of the heat exchanger. The sensed values are received by a control unit which processes them to compute percentage opening of the control valve, and generate an actuating signal. An actuator is configured to receive the actuating signal to control the actuation of the control valve and allow flow of steam from the control valve at a controlled flow rate into the heat exchanger.

### FIELD

The present disclosure relates to devices employed for controlling the process fluid parameters (temperature/pressure/flow) while simultaneously limiting the downstream pressure of steam supplied to heat exchangers to pre-defined values and indicating the flow rate of steam passing through the heat exchangers.

### BACKGROUND

The background information herein below relates to the present disclosure but is not necessarily prior art.

In process-related industries, steam is most commonly used in a heat exchanger for heating the process fluid. To control the temperature of the process fluid at the outlet of the heat exchanger, it is necessary to control the flow rate of steam. The conventional method to control the flow rate is by controlling the temperature alone.

The conventional devices for limiting the downstream pressure of steam supplied to process works with the help of one fluid parameter at a time. The parameters include i.e., either temperature or pressure or flow rate. The conventional apparatus comprises a steam flow meter which measures the flow rate of the steam let in the device. The device further comprises a pressure reducing valve for reducing the pressure of the steam. A first controller and a first position sensor are coupled to the valve to sense and control the pressure reducing valve based on the pressure. The device also comprises a temperature reducing valve that is coupled to a second sensor and a second position to position the temperature reducing valve based on the sensed temperature of the steam.

However, since pressure and temperature directly proportional to each other, once the pressure is reduced by the pressure reducing valve, the temperature is directly affected, which in turn may affect the temperature reduced by the temperature reducing valve. As a result, the mass flow rate is also hampered. To satisfy the three desired parameters of steam, more quantities of steam are pumped into the device with more energy. It has been further observed, that scaling occurs

There is therefore felt a need for a device that alleviates the aforementioned drawback.

### OBJECTS

Some of the objects of the present disclosure, which at least one embodiment herein satisfies, are as follows:

An object of the present disclosure is to provide a device for controlling steam flow in a steam line.

Another object of the present disclosure is to provide a device for controlling steam flow in a steam line while ensuring prevention of loss of steam.

Yet another object of the present disclosure is to provide a device for controlling steam flow in a steam line with relatively lesser amounts of energy consumption.

Other objects and advantages of the present disclosure will be more apparent from the following description, which is not intended to limit the scope of the present disclosure.

### SUMMARY

The present disclosure envisages a device, of the present disclosure for controlling steam flow in a steam line in a steam line.

In an embodiment, the steam line is employed for a heat exchanger.

The device includes a control valve, at least one first pressure sensing unit, control unit and an actuator. The control valve is configured to be positioned along the steam line. The pressure sensing unit is positioned upstream of the control valve. The first pressure sensing unit is configured to sense the pressure of steam at an inlet of the control valve, and is further configured to generate a first sensed pressure value. The temperature sensing unit is provided downstream of the heat exchanger. The temperature sensing unit is configured to sense the temperature of fluid led out of the heat exchanger, and is further configured to generate a sensed temperature value.

The control unit is configured to communicate with the first pressure sensing unit and the temperature sensing unit to receive the sensed first pressure value and the sensed temperature value. The control unit is configured to process the received values based on a set of prestored set of rules to compute percentage opening of the control valve. The control unit is further configured to generate an actuating signal based on the computed percentage opening.

The actuator is configured to communicate with the control unit to receive the actuating signal. The actuator is further configured to control the actuation of the control valve based on the actuating signal to allow flow of steam from the control valve at a controlled flow rate into the heat exchanger.

In an embodiment, the control unit includes a repository, a computing unit and a comparator. The repository is configured to store the prestored set of rules, a predetermined value of pressure and a predetermined value of temperature therein. The computing unit is configured to compute steam flow parameters based on the set of rules and the predetermined value of temperature. The comparator is configured to receive the predetermined values, the sensed values, and the computed values. The comparator is configured to compare the sensed values with the computed values and predetermined values to generate a compared signal.

The computing unit is configured to receive the compared signal to compute the percentage opening of the control valve and generate the actuating signal.

In one embodiment, the device includes at least one second pressure sensing unit positioned downstream of the control valve. The second pressure sensing unit is configured to sense the pressure of steam at an outlet of the control valve, and is further configured to generate a second sensed pressure value.

In another embodiment, the comparator is configured to receive the second sensed pressure value. The comparator is further configured to compare the second sensed pressure value with said computed pressure value to run the device at optimum pressure.

In an embodiment, the actuator is a control valve.

### BRIEF DESCRIPTION OF THE ACCOMPANYING DRAWING

A device, of the present disclosure, for controlling steam flow in a steam line will now be described with the help of the accompanying drawing, in which:

FIG. 1 illustrates a flow diagram representing the working of the device, in accordance with a preferred embodiment of the present disclosure and

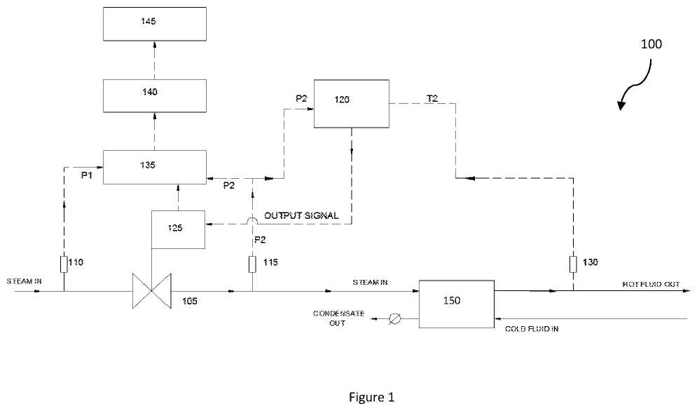

FIG. 2 illustrates a flow diagram representing the working of a heat exchanger.

### LIST OF REFERENCE NUMERALS

105—control valve
110—First pressure sensing unit
115—Second pressure sensing unit
120—Computing unit
125—Actuator
130—Temperature sensing unit
135—Comparator
140—Display unit
145—Data transmission unit
150—Heat exchanger

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, operations, elements, modules, units and/or components, but do not forbid the presence or addition of one or more other features, operations, elements, components, and/or groups thereof.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

The conventional device for limiting the downstream pressure of steam supplied to process works with the help of one fluid parameter at a time. The parameters include i.e., either temperature or pressure or flow rate. The conventional device comprises a steam flow meter which measures the flow rate of the steam let in the device. The conventional device further comprises a pressure reducing valve for reducing the pressure of the steam. A first controller and a first position sensor are coupled to the valve to sense and control the pressure reducing valve based on the pressure. The device also comprises a temperature reducing valve that is coupled to a second sensor and a second position to position the temperature reducing valve based on the sensed temperature of the steam.

However, since pressure and temperature directly proportional to each other, once the pressure is reduced by the pressure reducing valve, the temperature is directly affected, which in turn may affect the temperature reduced by the temperature reducing valve. As a result, the mass flow rate is also hampered. To satisfy the three desired parameters of steam, more quantities of steam are pumped into the device with more energy. It has been further observed, that scaling occurs in such heat exchangers.

The present disclosure envisages a device (100), of the present disclosure for controlling steam flow in a steam line.

In an embodiment, the steam line is employed for a heat exchanger (150).

The device (100) is configured to control steam flow by using a combination of temperature control along with steam pressure control by limiting the steam pressure value between pre-defined lower and higher limits. In addition, the device (100) uses optimization technique to run the device (100) at lowest pressure.

The device (100) includes a control valve (105), at least one first pressure sensing unit (110), a control unit and an actuator (125). The control valve (105) is configured to be positioned along the steam line. Steam is let out of the control valve (105) to a heat exchanger (150).

The pressure sensing unit is positioned upstream of the control valve (105). The first pressure sensing unit (110) is configured to sense the pressure of steam at an inlet of the control valve (105), and is further configured to generate a first sensed pressure signal. The temperature sensing unit (130) is provided downstream of the heat exchanger (150). The temperature sensing unit (130) is configured to sense the temperature of fluid led out of the heat exchanger (150), and is further configured to generate a sensed temperature value.

The control unit is configured to communicate with the first pressure sensing unit and the temperature sensing unit (130) to receive the sensed first pressure value and the sensed temperature value. The control unit is configured to process the received signals based on a set of prestored set of rules to compute percentage opening of the control valve (105).

The actuator (125) is configured to communicate with the control unit to receive the actuating signal. The actuator is further configured to control the actuation of the control valve (105) based on the actuating signal to allow flow of steam from the control valve (105) at a controlled flow rate into the heat exchanger (150).

In an embodiment, the control unit includes a repository, a computing unit (120) and a comparator (135). The repository is configured to store the prestored set of rules, a predetermined value of pressure and a predetermined value of temperature therein. The computing unit (120) is configured to compute steam flow parameters based on the set of rules and the predetermined value of temperature. The comparator (135) is configured to receive the predetermined values, the sensed values, and the computed values to generate a compared signal.

The computing unit (120) is configured to receive the compared signal to compute the percentage opening of the control valve (105) and generate the actuating signal.

The computation is based on the following logic implemented using the set of rules:

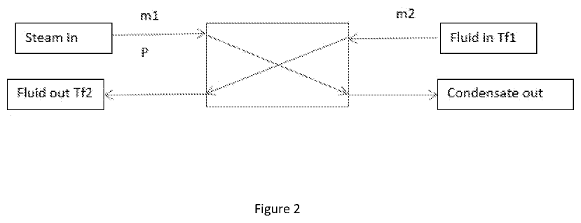

Referring to FIG. 2, in the heat exchanger (150), the fluid at temperature Tf1 is heated to temperature Tf2 using saturated steam as heating medium. The temperature Tf2 is to be maintained at pre-determined value. The temperature Tf2 will get changed if there is change in either fluid temperature Tf1 or fluid flow m2. Hence in order to accommodate this change and bringing back the temperature Tf2 back to preset value, the steam flow rate m1 needs to be changed. The steam flow rate m1 is a function of pressure P1, pressure P2 and valve opening.
m1: Mass flow rate of steam
m2: Mass flow rate of fluid
P: Pressure of saturated steam
h1: Enthalpy of saturated steam at pressure P
h2: Enthalpy of condensate
Cp2: Specific heat of fluid
Heat gained by fluid=Heat given by steam
m2·Cp2·(Tf2−Tf1)=m1·(h1−h2)
Hence m1=[m2·Cp2·(Tf2−Tf1)/(h1−h2)]

The value of h2 is taken as enthalpy of condensate at saturation pressure P for practical purpose. The denominator value (h1−h2) also called latent heat of steam is inversely proportional to pressure P. The value of (h1−h2) increases if the pressure P is reduced. Thus the steam flow rate requirement to maintain the same fluid temperature Tf2 is less if the steam pressure is reduced thereby resulting in steam savings.

Saturated steam at typically 4 bar gauge is available in the distribution header. The invention reduces the pressure further in order to achieve steam saving.

The below table illustrates the values of latent heat values of steam at different pressure condition.

TABLE 1

| Steam | | |
|---|---|---|
| pressure | Latent heat | Potential |
| (P) bar | (h1-h2) | Savings |
| gauge | kJ/kg | (%) |
| 4 | 2107 | 0 |
| 3 | 2133 | 1.2 |
| 2 | 2163 | 2.6 |
| 1 | 2201 | 4.5 |

In one embodiment, the device (100) includes at least one second pressure sensing unit (115) positioned downstream of the control valve (105). The second pressure sensing unit (115) is configured to sense the pressure of steam at an outlet of the control valve (105), and is further configured to generate a second sensed pressure value.

A predetermined temperature value and a predetermined pressure value are fed to the repository. Based on the pre-determined temperature value and a predetermined pressure value, the computing unit computes the maximum temperature of steam to be supplied. The saturation pressure of the maximum steam temperature is computed and set as the maximum limit of steam pressure.

In an embodiment, the control unit is configured to run multiple control loops with parameters of sensed temperature value, predetermined temperature value, and second sensed pressure value, to analyse the effect of incremental change in opening and closing of the control valve (105) based on the change in predetermined temperature value and second sensed pressure value.

In addition, the control unit iteratively computes a pressure value between an initially predetermined pressure value and the computed pressure value, and assigns it as a next pressure setpoint and changes it dynamically so that the sensed temperature value matches the predetermined temperature value. This strategy achieves the following objectives:
1) Sensed temperature value will match the predetermined temperature value;
2) The device (100) always runs at the optimum steam pressure;
3) The computed pressure value for steam pressure helps in protecting the heat exchanger (150); and
4) The device (100) acts as a combination of a pressure reducing valve and a temperature control valve which is an improvement over the conventional devices where at least two different valves were required for achieving the same results.

In an embodiment, the control unit can be implemented as one or more microprocessors, microcomputers, microcontrollers, digital signal processors, central processing units, state machines, logic circuitries, and/or any devices that manipulate signals based on operational instructions.

In an embodiment, the actuator (125) is a control valve (105).

In an embodiment, a display unit (140) is communicatively coupled to the computation unit. The display unit (140) is configured to display from a group of data including the sensed pressure and temperature values.

In an embodiment, a data transmission unit (145) is coupled to the computation unit. The data transmission unit (145) is configured to transmit the calculated data by computation unit to other remote devices via a network. In an embodiment, the data transmission unit (145) transmits the calculated data by selecting one of the wireless networks such as the Internet, one or more telecommunications networks as a wireless network, a wireless area network, a Wireless Video Are Network (WVAN), a Local Area Network (LAN), a WLAN, a PAN, a WPAN, WANs, metropolitan area networks (MANs), 4G/5G Hotspot, a WI-FI connection or an intranet.

The effect of the device (100) is such that if the steam temperature in the heat exchanger (150) is reduced, it is possible to have faster valve response to fluctuation in load. Since steam temperature is directly proportional to steam pressure, lowering the steam pressure at the inlet of heat exchanger (150) will result in lower steam temperature and improved accuracy of process fluid temperature control due to faster valve response.

Further, if the pressure downstream of the control valve (105) is above critical pressure, then steam flow rate depends on both upstream and downstream pressure and also valve opening.

Any fluctuation in downstream pressure can change the steam flow rate deviating from value required to achieve temperature of process fluid.

Then again, if the pressure downstream of control valve (105) is restricted to below critical pressure value, then the steam flow rate passing through the valve gets choked i.e. it is independent of downstream pressure of control valve (105). Since valve upstream pressure is fairly constant, hence the steam flow rate can be precisely controlled by valve opening irrespective of any fluctuations in downstream pressure below critical pressure. Thus process temperature control i.e. steam flow control is better and more stable.

Additionally, as the steam pressure is reduced, the steam flow requirement for same load is reduced due to higher latent of steam at reduced pressure. Hence there is a potential saving of steam used. Another advantage is that the device (100) indicates the flow rate of steam passing through it.

In an embodiment, the device (100) is configured to employed in shell & tube heat exchangers, plate heat exchangers, spiral heat exchangers, straight tube heat exchangers, U-tube heat exchangers, and cross flow heat exchanger.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### TECHNICAL ADVANCEMENTS

The present disclosure described hereinabove has several technical advantages including, but not limited to, the realization of device for controlling steam flow in a steam line, which:
prevents loss of steam; and
consumes relatively lesser amounts of energy.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A device (100) for controlling steam flow in a steam line of a heat exchanger (150), said device (100) being configured to be positioned upstream of said heat exchanger (150), said device (100) comprising:
a control valve (105) positioned along said steam line;
at least one first pressure sensing unit (110) positioned upstream of said control valve (105), said first pressure sensing unit (110) configured to sense the pressure of steam at an inlet of said control valve (105), and further configured to generate a first sensed pressure value;
at least one temperature sensing unit (130) provided downstream of the heat exchanger (150), said temperature sensing unit (130) configured to sense the temperature of fluid led out of the heat exchanger (150), and further configured to generate a sensed temperature value;
a control unit configured to communicate with said first pressure sending unit and said temperature sensing unit (130) to receive said first sensed pressure value and said sensed temperature value, said control unit configured to process said received signals based on a set of prestored set of rules to compute percentage opening of said control valve (105), and generate an actuating signal based on said computed percentage opening; and
an actuator (125) configured to communicate with said control unit to receive said actuating signal, and further configured to control the actuation of said control valve (105) based on said actuating signal to allow flow of steam from said control valve (105) at a controlled flow rate into the heat exchanger (150).

2. The device (100) as claimed in claim 1, wherein said control unit includes:
a repository configured to store said prestored set of rules, a predetermined value of pressure and a predetermined value of temperature;
a computing unit (120) configured to compute steam flow parameters based on said set of rules and said predetermined value of temperature; and
a comparator (135) configured to communicate with said repository to receive said predetermined values, said sensed values, and said computed values, said comparator (135) configured to compare said sensed values with said computed values and said predetermined values to generate a compared signal;
wherein said computing unit (120) is configured to receive said compared signal to compute the percentage opening of said control valve (105) and generate said actuating signal.

3. The device (100) as claimed in claim 1, which includes at least one second pressure sensing unit (115) positioned downstream of said control valve (105), said second pressure sensing unit (115) configured to sense the pressure of steam at an outlet of said control valve (105), and further configured to generate a second sensed pressure value.

4. The device (100) as claimed in claim 3, wherein said comparator (135) is configured to receive said second sensed pressure value, and is further configured to compare the second sensed pressure value with said computed pressure value to facilitate running of said device at optimum pressure.

5. The device (100) as claimed in claim 1, wherein said actuator (125) is a control valve (105).
